(19) United States
(12) Patent Application Publication
(10) Pub. No.: US 2015/0026658 A1
(43) Pub. Date: Jan. 22, 2015

(54) Systems, Methods and Media for Dynamic Creation and Update of Activation Context for Component Object Model

(71) Applicant: AppSense Limited, Warrington (GB)

(72) Inventor: Stephen JONES, Manchester (GB)

(21) Appl. No.: 13/945,714

(22) Filed: Jul. 18, 2013

(51) Int. Cl. G06F 9/44

(52) U.S. Cl. CPC G06F 8/315
USPC 717/108

(57) ABSTRACT

Systems, methods and media are provided for dynamically creating/updating an activation context at runtime. One method includes receiving a request to create a component object, the request including a component identification of the requested component. The method also includes accessing a type library associated with each of multiple executable files. The type library includes an identification of each executable file and library content. The method further includes updating a manifest at runtime by enumerating the library content of each executable file and adding to the manifest the identification and the enumerated library content. The method also includes creating an activation context based on the updated manifest and determining using the component identification whether the activation context includes the requested component. The method further includes activating the activation context and creating the requested component object using the activation context, when it is determined that the activation context includes the requested component.

### TECHNICAL FIELD

Disclosed systems, methods and media relate to dynamic creation and update of an activation context for COM components. Specifically, disclosed systems, methods and media relate to improving Side-by-Side (SxS) COM activation by dynamically creating and updating an activation context for COM components.

### BACKGROUND

The Component Object Model (COM) is an object-based programming model designed to promote software interoperability, which allows two or more applications or “components” to cooperate easily with one another. COM enables cooperation of two or more components even if the components were written/programmed by different software vendors at different times, in different programming language, or if they are running on different machines/systems running different operating systems. A component in COM, therefore, means a language independent software module. COM enables a software developer to combine disparate software parts (components) together at run-time and promotes reuse of existing, tested components.

COM is also a specification that explains methods and techniques by which applications (application programs) are built from disparate components. A COM component and an application (client or client program) interact with each other through interface(s). An interface is a strongly typed contract between a software component and a client program. A component (a COM component or component in compliance with COM specification) may be either a dynamic link library (DLL) or a stand-alone, executable program (an EXE file—i.e., a file with an “.exe” extension).

In addition to being a specification, COM is also an implementation contained in what is referred to as “COM Library.” The implementation is provided through a library (e.g., DLL on MS-Windows™) that typically includes a number of fundamental application programming interface (API) functions that facilitate the creation of COM applications (both clients and servers). The library may also include an implementation of locator services through which COM determines from a class identifier which COM server, or component, implements that class and where that component is located.

A client (client program) is any piece of code that obtains a pointer through which it can access the services of a component object and then invokes those services when necessary. A server (e.g., COM component) is some piece of code that implements the object and structures in such a way that the COM Library can match that implementation to a class identifier (CLSID). The COM Library uses the CLSID to provide “implementation locator services” to clients. A client needs to tell COM only the CLSID it wants and COM, in turn, locates the implementation of that class and establishes a connection between the implementation and the client. A COM object is an object that is identified by a unique 128-bit CLSID that associates an object class with a particular implementation of the object class (e.g., a DLL or an EXE file in the file system).

On its host system, for example, COM maintains a registration database, or “registry,” of all the CLSIDs for the servers (components) installed on the system—i.e., a mapping between each CLSID and the location of the DLL or EXE file that houses the server for that CLSID. COM consults this database whenever a client wants to create an instance of a COM class (i.e., a COM object) and uses its services. The fact that a client only needs to know the CLSID of a desired component keeps the client independent of the specific location of the DLL or EXE file on the particular machine.

FIGS. 1-2 are function call flow diagrams 100, 200 showing, for example, how a client program, such as a Test Runner 102, gains, or is denied, access to a particular COM component object, respectively. Referring to FIG. 1, a Test Runner 102, which may be a program that is implemented to perform unit-testing of a new COM component, invokes CoCreateInstance( ) function 108 to gain access to a COM component object. CoCreateInstance, which is a part of an API provided by the Windows™ Operating System (Win32 API) 104, is called to create an object of a class associated with a CLSID that is passed to the function as an input function parameter—e.g., CoCreateInstance (CLSID). Upon an invocation of CoCreateInstance function by Test Runner 102, the Windows™ OS (Win32 API 104) sends a request 110 to Windows™ Registry 106 to determine whether the requested COM component is registered in Registry 106 using the CLSID. Registry 106 returns to Win32 API 104 information including a correct path 112 (e.g., file path) to the requested COM component (e.g., a DLL)—i.e., file path showing the location of the DLL file(s). Win32 API 104 uses the file path to load the DLL at 114 and creates the requested COM component object at 116. Win32 API 104 then returns to Test Runner 102 a pointer 118 to the IUnknown interface of the requested COM component object—i.e., the invoked CoCreateInstance API function returns (meaning that the called function ends its execution and gives the control back to its caller) with the pointer to the IUnknown interface.

Referring to FIG. 2, if it is determined that the requested COM component is not registered in Registry 106, however, Registry 106 sends back to Win32 API 104 a message 202 indicating that the CLSID is not found in Registry 106 (e.g., “Not Found”). Win32 API 104 in turn returns an error message 204 back to Test Runner 102, indicating that the component is not registered (e.g., “REGDB_E_CLASSNOTREG” message).

This mechanism of creating a COM object, as shown above, requires that the component that should be activated to create the COM object be registered in the system registry prior to calling an appropriate API function (e.g., CoCreateInstance( )) in COM Library for creating a COM component object. There are, however, a number of reasons why this mechanism is not desirable. First, a component file (e.g., DLL or EXE file) can be deleted without unregistering the associated component CLSID, leaving an orphan entry in the system registry that points to a file that is no longer present. Second, it is difficult to conduct a unit testing of a component because the component must be registered prior to conducting the testing and deregistered afterwards. Third, it can cause system instability when running a unit testing if the component being tested is used elsewhere on the system.

To address these issues, a technique for isolating a component (referred to as “Side-by-Side (SxS) Activation”) is introduced. For example, the isolation technique uses a manifest (e.g., an eXtensible Markup Language (XML) file) containing the CLSIDs for the components that should be loaded from a local folder. A process responsible for creating a COM object in response to a client's request uses the manifest to load necessary components from a local folder. This technique works relatively well as long as the set of CLSIDs that are required for creating a COM object is known at the time the client is compiled. If, however, a software developer is building a client program that is extensible and is capable of using components that have yet been created, this type of SxS Activation does not work well because the developer of the client program cannot obtain the CLSIDs of yet-to-be-built components.

### SUMMARY

In accordance with the disclosed subject matter, systems, methods and media are provided for dynamic creation and update of an activation context for COM components. Specifically, disclosed systems, methods and media provide for dynamically creating and updating an activation context for COM components for testing COM components located in a local folder.

The disclosed subject matter includes a method. The method includes receiving from an application program a request to create an object of a software component. The request includes a component identification of the requested software component. The method also includes accessing a type library associated with each of a plurality of executable files contained in a local file directory. The type library includes an identification of the each executable file and library content including at least one of one or more classes, one or more interfaces, and one or more type definitions that are implemented by the each executable file. The method further includes updating a manifest contained in a data file at runtime by enumerating the library content of the each executable file and adding to the data file the identification and the enumerated library content of the each executable file. The method also includes creating an activation context based on the updated manifest and determining using the component identification whether the activation context includes the requested software component. When it is determined that the activation context includes the requested software component, the method also includes activating the activation context and creating an object of the requested software component using the activation context.

In some embodiments, the method further includes passing a reference to the object of the requested software component to the application program. The reference is used to provide access to one or more services that are provided by the object. In some embodiments, the software component includes one of a component object model (COM) component and a distributed COM (DCOM) component. In some embodiments, the component identification includes a class ID (CLSID) of the requested COM or DCOM component. In some embodiments, the type library includes one of an embedded type library and an external type library. In some embodiments, the plurality of executable files includes at least one of one or more stand-alone executable (EXE) files and one or more dynamic link library (DLL) files. In some embodiments, the manifest includes a Side-by-Side (SxS) manifest and the data file includes an XML file.

In some embodiments, the method further includes searching a system registry to determine whether the system registry includes the requested software component using the component identification when it is determined that the activation context does not include the requested software component. When it is determined that the system registry includes the requested software component, the method may also include creating an object of the requested software component by loading one or more executable files using a file path to the one or more executable files. The file path is found in the system registry.

The disclosed subject matter also includes an apparatus including one or more interfaces configured to provide communication with at least one mobile node over a network. The apparatus can also include a processor, in communication with the one or more interfaces, configured to run a module stored in memory that is configured to receive from an application program a request to create an object of a software component. The request includes a component identification of the requested software component. The module run by the processor is also configured to access a type library associated with each of a plurality of executable files contained in a local file directory. The type library includes an identification of the each executable file and library content including at least one of one or more classes, one or more interfaces, and one or more type definitions that are implemented by the each executable file. The module run by the processor is further configured to update a manifest contained in a data file at runtime by enumerating the library content of the each executable file and adding to the data file the identification and the enumerated library content of the each executable file. The module run by the processor is also configured to create an activation context based on the updated manifest and determine using the component identification whether the activation context includes the requested software component. When it is determined that the activation context includes the requested software component, the module run by the processor is also configured to activate the activation context and create an object of the requested software component using the activation context.

The disclosed subject matter further includes a non-transitory computer readable medium. The computer readable medium can have executable instructions operable to cause an apparatus to receive from an application program a request to create an object of a software component. The request includes a component identification of the requested software component. The executable instructions are also operable to cause the apparatus to access a type library associated with each of a plurality of executable files contained in a local file directory. The type library includes an identification of the each executable file and library content including at least one of one or more classes, one or more interfaces, and one or more type definitions that are implemented by the each executable file. The executable instructions are further operable to cause the apparatus to update a manifest contained in a data file at runtime by enumerating the library content of the each executable file and adding to the data file the identification and the enumerated library content of the each executable file. The executable instructions are also operable to cause the apparatus to create an activation context based on the updated manifest and determine using the component identification whether the activation context includes the requested software component. When it is determined that the activation context includes the requested software component, the executable instructions are also operable to cause the apparatus to activate the activation context and create an object of the requested software component using the activation context.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto.

In this respect, before explaining at least one embodiment of the disclosed subject matter in detail, it is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the disclosed subject matter. It is important, therefore, that the claims be regarded as including such equivalent constructions insofar as they do not depart from the spirit and scope of the disclosed subject matter.

These together with the other objects of the disclosed subject matter, along with the various features of novelty which characterize the disclosed subject matter, are pointed out with particularity in the claims annexed to and forming a part of this disclosure. For a better understanding of the disclosed subject matter, its operating advantages and the specific objects attained by its uses, reference should be had to the accompanying drawings and descriptive matter in which there are illustrated preferred embodiments of the disclosed subject matter.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 is a function call flow diagram of CoCreateInstance( ) API function for creating a COM component object using the Windows™ Registry.

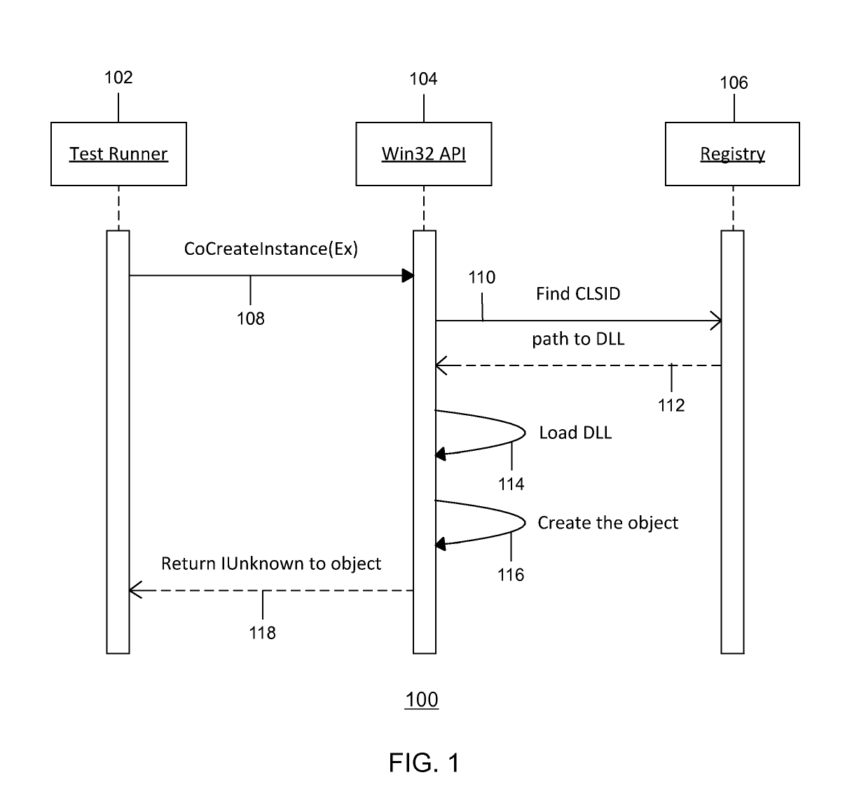

FIG. 2 is a function call flow diagram of CoCreateInstance( ) API function when a requested COM component is not yet registered in the Windows™ Registry.

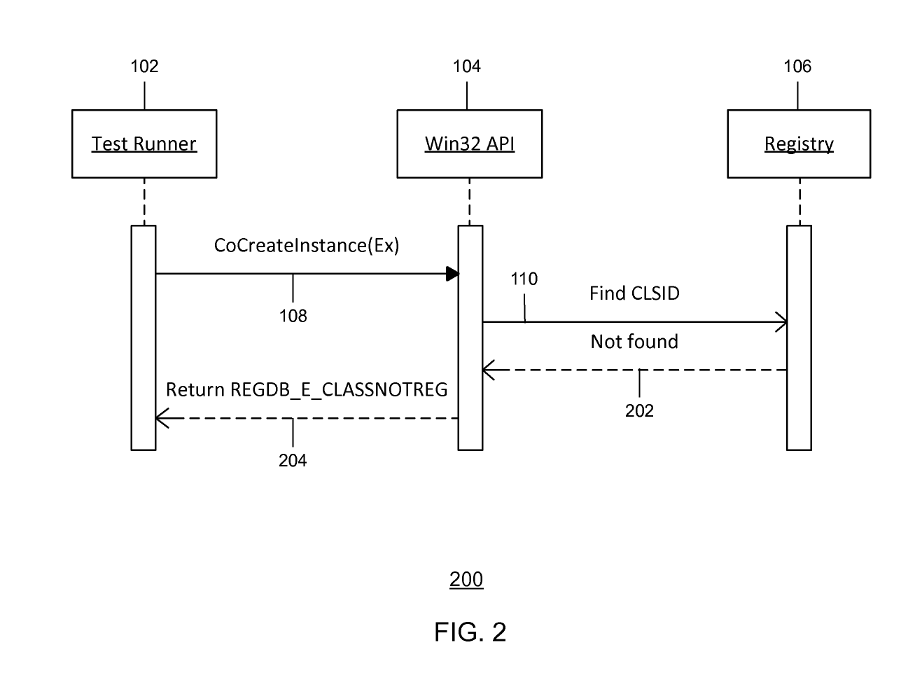

FIG. 3 is a function call flow diagram of CoCreateIsolatedInstance( ) wrapper function for creating a COM component object using dynamic activation context created at runtime in accordance with certain embodiments of the disclosed subject matter.

FIG. 4 is a function call flow diagram of GetIsolatedComActivationContext( ) function for activating a dynamically created activation context in accordance with certain embodiments of the disclosed subject matter.

FIG. 5 is a function call flow diagram of InitializeComManifest( ) function for dynamically building a manifest and a context map and creating an activation context in accordance with certain embodiments of the disclosed subject matter.

FIG. 6 is a block diagram of a computing device in accordance with certain embodiments of the disclosed subject matter.

### DETAILED DESCRIPTION

In the following description, numerous specific details are set forth regarding the systems, methods and media of the disclosed subject matter and the environment in which such systems, methods and media may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the examples provided below are exemplary, and that it is contemplated that there are other systems, methods and media that are within the scope of the disclosed subject matter.

The disclosed subject matter relates to systems, methods and media for dynamic creation and update of an activation context for COM components. Specifically, disclosed systems, methods and media provide for dynamically creating and updating an activation context for COM components for testing COM components located in a local folder.

Activation context is a data structure containing information that a system can use to redirect an application to load a particular DLL version, COM object instance or custom window version. Activation context functions can use, create, activate and deactivate activation contexts. In particular, the activation context functions can redirect the binding of an application to (version-named) objects that specify particular DLL versions, windows classes, COM servers, type libraries and interfaces (e.g., local copy of a registered COM component, a new COM component that is being unit-tested, etc.). Activation context functions can also enable Windows™ OS to use information in manifests to create version-named objects. If an application program is instantiated (i.e., creates a process by calling, e.g., CreateProcess API function), for example, Windows™ OS checks for the existence of an application manifest for the application program. If an application manifest exists, Windows™ OS uses the information in the manifest to populate the activation context.

A type library (e.g., files having “.tlb” extension) is a binary file that stores information about a COM object's properties and methods in a form that is accessible to other applications at runtime. Using a type library, for instance, an application program can determine which interfaces an object supports.

In some embodiments, for example, a programmer has developed a new interface having a set of member functions for a COM component and wants to test the member functions of the new interface before deploying the new version of the COM component by registering the new version with the system registry (e.g., Windows™ Registry). Currently, the previous version of the COM component is registered in the system registry and thus used by the rest of the system's programs and software modules that require the services provided by the COM component. Rather than risking the system integrity/stability by registering the new, untested version of the COM component along with the older version of the COM component, the programmer chooses to isolate the new version of the COM component in a local directory and test it from the isolated local directory. The programmer saves the files implementing the new version of the COM component in the local directory. Testing the COM component also requires a testing application program (“testing application”) as well as a few other executable files and dynamic link libraries (DLLs), and thus the programmer also saves a local copy of those executable files and DLLs, thereby completely isolating the environment for testing the new interface of the COM component.

The testing application simulates an application program that calls the new interface member functions of the COM component to determine whether the member functions correctly perform the intended tasks under varying conditions. In particular, the testing application, rather than calling Win32 API functions to locate and instantiate the new version of the COM component, invokes a series of Isolated API functions (e.g., wrapper functions) to create necessary COM component objects. Instead of invoking Win32 API function, CoCreateInstance( ), to locate the relevant DLLs and instantiate a COM object, for example, the testing application invokes an isolated wrapper API function, CoCreateIsolatedInstance( ).

CoCreateIsolatedInstance function, if invoked for the first time, dynamically builds a manifest and a context map at runtime. In addition, CoCreateIsolatedInstance function, unlike CoCreateInstance function that checks the system registry to locate and load a requested COM component, creates an activation context that can act as an isolated local registry including information about all the components, modules and executable files that are placed in the local directory for testing the new version of the COM component. For instance, CoCreateIsolatedInstance function opens the type library associated with each of the DLLs and other types of executable files to read the classes, interfaces and type definitions from the type library (library content) and adds the library content to an XML document to create a runtime SxS manifest. Once the dynamically created SxS manifest is generated, CoCreateIsolatedInstance function creates an activation context based on the updated manifest and updates the ContextMap associated with the manifest by adding the CLSIDs of the DLLs and other executable files to the ContextMap.

CoCreateIsolatedInstance function also creates necessary COM component objects (COM objects) at runtime. For example, CoCreateIsolatedInstance function, once the activation context created based on the dynamically created SxS manifest is activated, invokes CoCreateInstance function, which it wraps, to load the local copy of one or more DLLs (and other executable files) associated with the requested COM component that are specified in the activation context to instantiate an object of the requested COM component.

Because the activation context is built based on a manifest that is dynamically updated at runtime, the programmer does not have to create and maintain the activation context manually. All the programmer has to do is to isolate the files that are related to testing the new version of the COM component by placing the files in the isolated local directory.

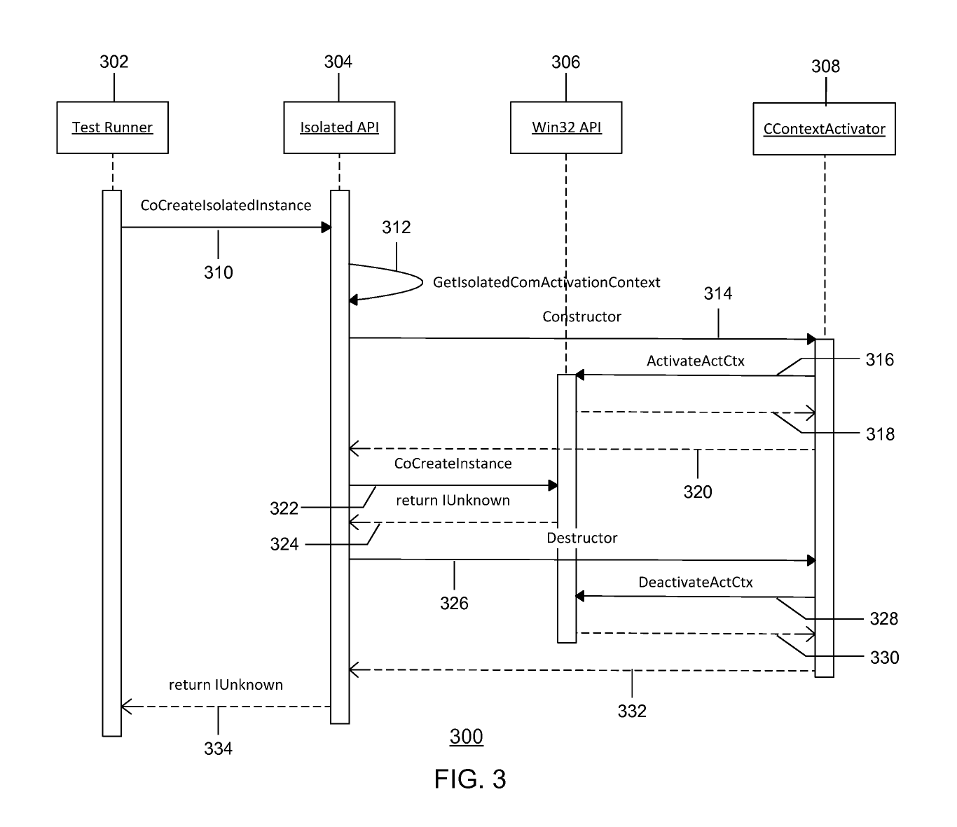

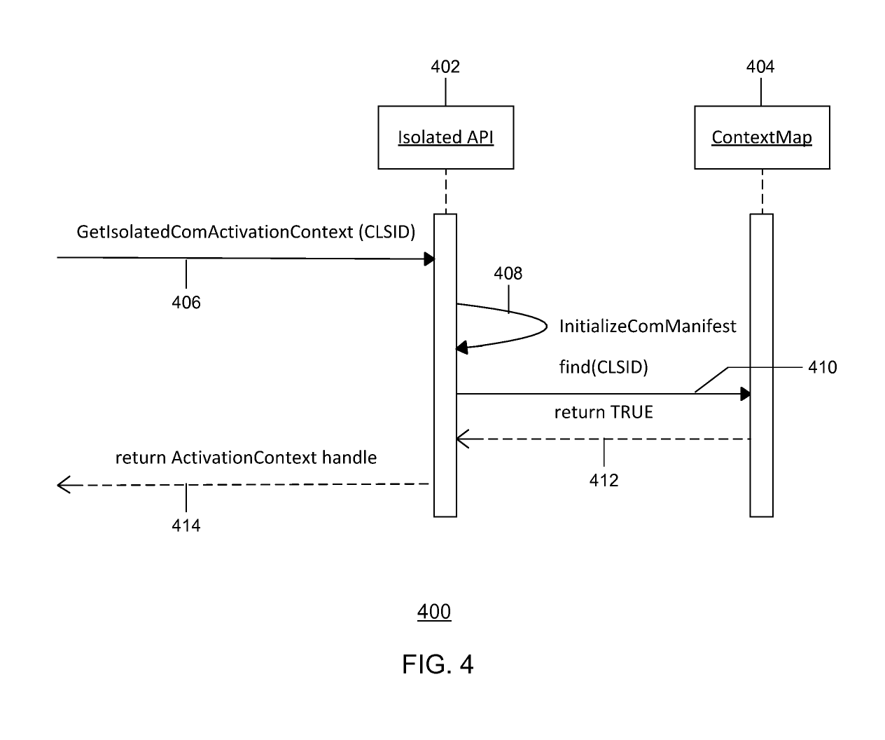

FIG. 3 is a function call flow diagram 300 of CoCreateIsolatedInstance( ) wrapper function for creating (a local version of) a COM component object using dynamically created activation context for the requested COM component in accordance with certain embodiments of the disclosed subject matter. A Test Runner 302 that is used to test (e.g., unit-test) a new COM component invokes an API wrapper function CoCreateIsolatedInstance( ) at 310 to create a COM component object associated with a particular class ID (CLSID) and gain access to the interface(s) supported by the component object. When invoked, the Isolated API function 304 (i.e., CoCreateIsolatedInstance function) first invokes another isolated API function, GetIsolatedActivationContext( ), at 312. GetIsolatedActivationContext, as explained more in detail below with respect to FIG. 4, populates an activation context based on a new, runtime created/initialized, or updated, manifest for the requested COM component. GetIsolatedActivationContext function, if successfully executed, returns to its caller (i.e., CoCreateIsolatedInstance function) a Handle to the populated activation context.

At 314, the Isolated API function 304 creates a CContextActivator object 308 (e.g., by invoking a CContextActivator's constructor) and passes the activation context Handle for activating the activation context associated with the Handle. At 316, the CContextActivator object 308 invokes ActivateActCtx function to activate the activation context using the Handle. ActivateActCtx is a Windows™ API function that activates a specified activation context by, e.g., pushing the activation context specified by the Handle to the top of the activation context stack. ActivateActCtx also associates the activated activation context with the current thread (e.g., the thread running the Test Runner 302 and any functions Test Runner 302 invokes). At 318, Windows™ OS (Win32 API 306—i.e., ActivateActCtx function) returns (e.g., returns TRUE), indicating the specified activation context is properly activated. At 320, CContextActivator notifies the Isolated API function 304 (i.e., CoCreateIsolatedInstance function) that the activation context associated with the Handle has been successfully activated and placed on top of the activation context stack.

At 322, the Isolated API function 304 invokes CoCreateInstance( ) API function with the CLSID of the requested COM component as an input parameter. Because the current thread is associated with the activated activation context, CoCreateInstance function, instead of searching Windows™ Registry 106, searches the activated activation context for the location information (e.g., file path) of (a local, or testing, version of) the requested COM component. At 324, CoCreateInstance function (i.e., Win32 API 306) creates an instance of the requested COM component object and returns a pointer to the IUnknown interface of the requested COM component object, thereby providing Test Runner 302 with access to member functions of the requested COM component object.

At 326, (e.g., after an instance of the local version of the requested COM component is created) the Isolated API function 304 deletes CContextActivator object by, e.g., invoking a CContextActivator's destructor. CContextActivator object in turn invokes DeactivateActCtx (Win32 API) function at 328 to deactivate the activation context associated with the current thread. At 330, DeactivateActCtx function returns, indicating that the activation context has been successfully deactivated. The CContextActivator's destructor returns at 332, indicating that CContextActivator object has been properly deleted and the resources associated with the object (e.g., dynamically allocated memory, activation context Handle, etc.) has been properly released. At 334, the Isolated API function 304 (i.e., CoCreateIsolatedInstance function) returns, passing the IUnknown interface pointer to Test Runner 302.

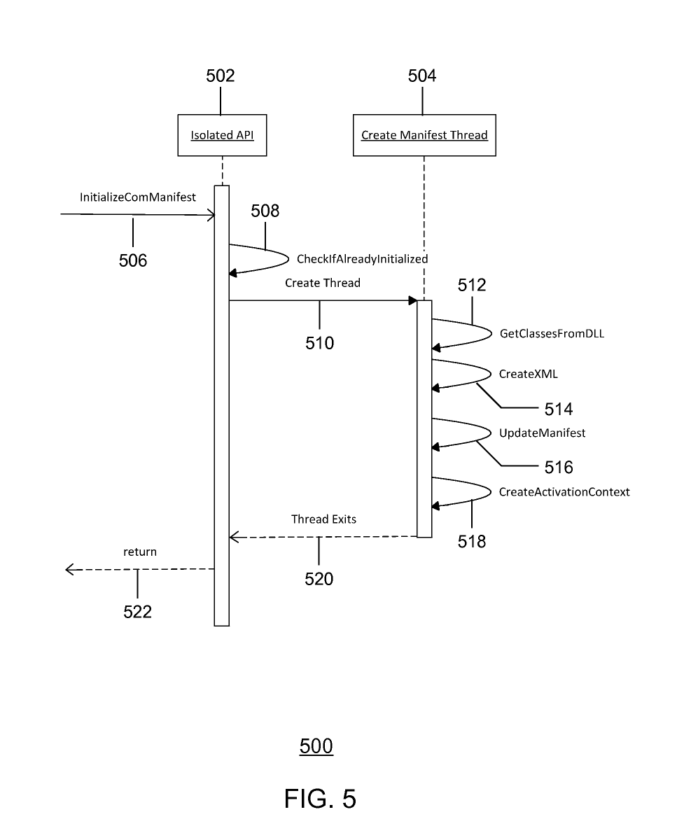

FIG. 4 is a function call flow diagram 400 of GetIsolatedComActivation-Contect( ) function for activating a dynamically created activation context in accordance with certain embodiments of the disclosed subject matter. At 406, GetIsolatedComActivationContext (CLSID) function is invoked, e.g., by another isolated API function, such as CoCreateIsolatedInstance( ), with a class identification (CLSID) for a requested COM component passed as an input parameter to the function. When called by another (isolated API) function, Isolated API function 402 (i.e., GetIsolatedComActivationContext function) invokes InitializeComManifest( ) function at 408, as described more in detail below with respect to FIG. 5, for creating/initializing, or updating, at runtime a (Side-by-Side) manifest and building an activation context based on the dynamically created/updated manifest.

At 410, Isolated API function 402 searches a ContextMap 404 to determine whether the requested COM component is present in ContextMap 404 using the class ID (CLSID) of the requested COM component by, e.g., invoking find (CLSID) function. At 412, the find function of ContextMap 404 returns TRUE, indicating that the requested COM component is present in ContextMap 404. At 414, Isolated API function 402 (i.e., GetIsolatedComActivationContext function) returns to the caller function a Handle of an activation context associated with ContextMap 404.

If, however, it is determined that the ContextMap 404 does not included the requested COM component (e.g., the component's CLSID), i.e., find (CLSID) function returns FALSE and thus no activation context handle is returned to the caller isolated API function (CoCreateIsolatedInstance function), in one embodiment, the caller API function is configured to invoke CoCreateInstance function to determine whether the system registry includes the requested COM component. For instance, this option may be desirable for running a live system that is designed to be extended dynamically by adding new COM components and referencing them in configuration file(s) or script(s). In some embodiments, the caller API function simply returns an error message, thereby allowing the CoCreateIsolatedInstance operation to fail. For instance, this option may be desirable for conducting a unit testing of one or more COM components.

FIG. 5 is a function call flow diagram 500 of InitializeComManifest( ) function for dynamically building a manifest and a context map and creating an activation context at runtime in accordance with certain embodiments of the disclosed subject matter. At 506, InitializeComManifest function is invoked within another isolated API function, such as GetIsolatedComActivationContext function, for dynamically creating an activation context for a requested COM component. When invoked, Isolated API function 502 (i.e., InitializeComManifest function) first determines whether a manifest associated with a local file path (e.g., local file folder) including COM components has already been initialized, e.g., by calling CheckIfAlreadyInitialized function at 508. CheckIfAlreadyInitialized function is invoked to ensure that each manifest is initialized only once.

At 510, Isolated API function 502 spawns a thread (e.g., CreateManifest Thread 504) for dynamically creating an activation context based on a manifest that is updated at runtime. For example, Isolated API function 502 can invoke CreateThread function to spawn a CreateManifest Thread 504. Once spawned, CreateManifest Thread 504 creates and/or updates the manifest and builds/populates an activation context based on the (updated) manifest. For example, CreateManifest Thread 504 invokes GetClassesFromDLL function at 512 for each DLL in a local folder. For instance, GetClassesFromDLL function opens a type library embedded to each DLL in the local folder, reads all classes, interfaces and type definitions of each DLL, and adds the library content to one or more arrays. In some embodiments, the library content is added to 3 separate arrays (e.g., class array, interface array, and type array). In some embodiments, the local folder is a file folder where all types of files (e.g., DLLs, stand-alone executable files, etc.) that are related to a testing of one or more COM components are stored.

Once the library content (classes/interfaces/type definitions) of each DLL (and other types of executable files) are read and stored in arrays, CreateManifest Thread 504 creates an XML file at 514 by, e.g., invoking CreateXML function, which creates an empty, or shell, XML document. At 516, CreateManifest Thread 504 updates a manifest using the array(s) containing the library content of each DLL/executable file by, e.g., invoking UpdateManifest function. UpdateManifest function iterates through the arrays (e.g., class array, interface array, type array) created by, e.g., GetClassesFromDLL function and adds each library content to the XML document. UpdateManifest function also adds each class identification (CLSID) to an accompanying ContextMap (e.g., ContextMap 404).

At 518, CreateManifest Thread 504 creates an activation context based on the updated manifest. For example, CreateManifest Thread 504 can invoke CreateActivationContext function to create an activation context. For instance, CreateActivationContext function stores the XML document containing the updated manifest in a temporary file and calls a Win32 API function, such as CreateActCtx function, to create an activation context based on the updated manifest. CreateActivationContext function also stores a Handle to the activation context generated by, e.g., CreateActCtx. The Handle to the activation context may be used later, e.g., for activating and deactivating the activation context.

CreateManifest Thread 504 exits, or terminates, at 520 once an activation context is created. At 522, Isolated API 502 (i.e., InitializeComManifest function) returns.

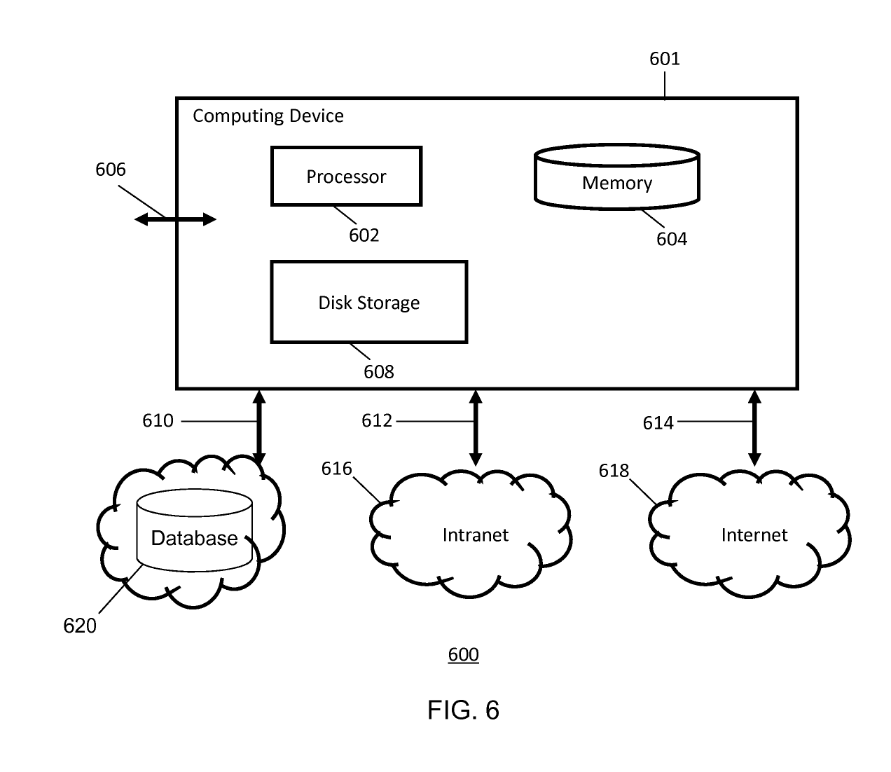

FIG. 6 is a block diagram 600 of a computing device in accordance with certain embodiments of the disclosed subject matter. Block diagram 600 shows a computing device 601, which includes a processor 602, a memory 604, interfaces 606, 610, 612, and 614, and a disk storage 608 including one or more software modules (e.g., DLLs including isolated API wrapper functions) and application programs (e.g., testing application programs). Block diagram 600 shows computing device 601 communicatively coupled to a database 620, an Intranet 616, and the Internet 618. Memory 604 and interfaces 606, 610, 612, and 614 are communicatively coupled to processor 602. Computing device 601 can communicate with one or more other computing devices (not shown) via interface 606; computing device 601 can communicate with database 620 via interface 610; computing device 601 can communicate with Intranet 616 via interface 612; and computing device 601 can communicate with the Internet 618 via interface 614. Interfaces 606, 610, 612, and 614 are shown as separate interfaces but may be the same physical interface. Processor 602 can run software modules and application programs included in disk storage 608. Memory 604 is capable of storing data that can be used by processor 602 to run the software modules and the application programs. In some embodiments, memory 604 includes a system registry, such as Windows™ Registry 106. In some embodiments, database 620 includes the system registry.

Interfaces 606, 610, 612, and 614 provide an input and/or output mechanism to communicate over a network. Interfaces 606, 610, 612, and 614 enable communication with other computing devices, as well as other network nodes in a communication network. Interfaces 606, 610, 612, and 614 can be implemented in hardware to send and receive signals in a variety of mediums, such as optical, copper, and wireless, and in a number of different protocols some of which may be non-transient. Computing device 601 may include additional modules, fewer modules, or any other suitable combination of modules that perform any suitable operation or combination of operations.

Computing device 601 can operate using operating system (OS) software. In some embodiments, the OS software is based on a Windows™ or Linux software kernel and runs specific applications in the computing device such as monitoring tasks and providing protocol stacks. In some embodiments, the OS software can allow computing resources to be allocated separately for control and data paths. For example, certain packet accelerator cards and packet services cards are dedicated to performing routing or security control functions, while other packet accelerator cards/packet services cards are dedicated to processing user session traffic. As network requirements change, hardware resources can be dynamically deployed to meet the requirements in some embodiments.

The computing device's software can be divided into a series of tasks that perform specific functions. These tasks communicate with each other as needed to share control and data information throughout computing device 601. A task can be a software process that performs a specific function related to system control or session processing. Three types of tasks operate within computing device 601 in some embodiments: critical tasks, controller tasks, and manager tasks. The critical tasks control functions that relate to the server's ability to process calls such as server initialization, error detection, and recovery tasks. The controller tasks can mask the distributed nature of the software from the user and perform tasks such as monitoring the state of subordinate manager(s), providing for intra-manager communication within the same subsystem, and enabling inter-subsystem communication by communicating with controller(s) belonging to other subsystems. The manager tasks can control system resources and maintain logical mappings between system resources.

Individual tasks that run on processors in the application cards can be divided into subsystems. A subsystem is a software element that either performs a specific task or is a culmination of multiple other tasks. A single subsystem includes critical tasks, controller tasks, and manager tasks. Some of the subsystems that run on computing device 601 include a system initiation task subsystem, a high availability task subsystem, a shared configuration task subsystem, and a resource management subsystem.

The system initiation task subsystem is responsible for starting a set of initial tasks at system startup and providing individual tasks as needed. The high availability task subsystem works in conjunction with the recovery control task subsystem to maintain the operational state of computing device 601 by monitoring the various software and hardware components of computing device 601. Recovery control task subsystem is responsible for executing a recovery action for failures that occur in computing device 601 and receives recovery actions from the high availability task subsystem. Processing tasks are distributed into multiple instances running in parallel so if an unrecoverable software fault occurs, the entire processing capabilities for that task are not lost. User session processes can be sub-grouped into collections of sessions so that if a problem is encountered in one sub-group users in another sub-group will not be affected by that problem.

Shared configuration task subsystem can provide computing device 601 with an ability to set, retrieve, and receive notification of server configuration parameter changes and is responsible for storing configuration data for the applications running within computing device 601. A resource management subsystem is responsible for assigning resources (e.g., processor and memory capabilities) to tasks and for monitoring the task's use of the resources.

In some embodiments, computing device 601 can reside in a data center and form a node in a cloud computing infrastructure. In some embodiments, computing device 601 can act as a server and provide services on demand. A module hosting a client is capable of migrating from one server to another server seamlessly, without causing program faults or system breakdown. In some embodiments, computing device 601 on the cloud can be managed using a management system.

Computing device 601 can include user equipment. The user equipment communicates with one or more radio access networks and with wired communication networks. The user equipment can be a cellular phone having phonetic communication capabilities. The user equipment can also be a smart phone providing services such as word processing, web browsing, gaming, e-book capabilities, an operating system, and a full keyboard. The user equipment can also be a tablet computer providing network access and most of the services provided by a smart phone. The user equipment operates using an operating system such as Symbian OS, iPhone OS, RIM's Blackberry, Windows Mobile, Linux, HP WebOS, and Android. The screen might be a touch screen that is used to input data to the mobile device, in which case the screen can be used instead of the full keyboard. The user equipment can also keep global positioning coordinates, profile information, or other location information.

Computing device 601 can also include any platforms capable of computations and communication. Non-limiting examples can include televisions (TVs), video projectors, set-top boxes or set-top units, digital video recorders (DVR), computers, netbooks, laptops, and any other audio/visual equipment with computation capabilities.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A method, comprising:
receiving from an application program a request to create an object of a software component, the request including a component identification of the requested software component;
accessing a type library associated with each of a plurality of executable files contained in a local file directory, wherein the type library includes an identification of the each executable file and library content including at least one of one or more classes, one or more interfaces, and one or more type definitions that are implemented by the each executable file;
updating a manifest contained in a data file at runtime by enumerating the library content of the each executable file and adding to the data file the identification and the enumerated library content of the each executable file;
creating an activation context based on the updated manifest;
determining using the component identification whether the activation context includes the requested software component; and
when it is determined that the activation context includes the requested software component,
activating the activation context; and
creating an object of the requested software component using the activation context.

2. The method of claim 1, further comprising passing a reference to the object of the requested software component to the application program, wherein the reference is used to provide access to one or more services that are provided by the object.

3. The method of claim 1, wherein the software component includes one of a component object model (COM) component and a distributed COM (DCOM) component.

4. The method of claim 3, wherein the component identification includes a class ID (CLSID) of the requested COM or DCOM component.

5. The method of claim 1, wherein the type library includes one of an embedded type library and an external type library.

6. The method of claim 1, wherein the plurality of executable files includes at least one of one or more stand-alone executable (EXE) files and one or more dynamic link library (DLL) files.

7. The method of claim 1, further comprising placing at least one of the plurality of executable files in the local file directory.

8. The method of claim 1, wherein the manifest includes a Side-by-Side (SxS) manifest and the data file includes an XML file.

9. The method of claim 1, further comprising:
searching a system registry to determine whether the system registry includes the requested software component using the component identification when it is determined that the activation context does not include the requested software component; and
when it is determined that the system registry includes the requested software component, creating an object of the requested software component by loading one or more executable files using a file path to the one or more executable files, wherein the file path is found in the system registry.

10. An apparatus, comprising:
one or more interfaces configured to provide communication with at least one mobile node over a network; and
a processor, in communication with the one or more interfaces, configured to run a module stored in a memory that is configured to:
receive from an application program a request to create an object of a software component, the request including a component identification of the requested software component;
access a type library associated with each of a plurality of executable files contained in a local file directory, wherein the type library includes an identification of the each executable file and library content including at least one of one or more classes, one or more interfaces, and one or more type definitions that are implemented by the each executable file;
update a manifest contained in a data file at runtime by enumerating the library content of the each executable file and adding to the data file the identification and the enumerated library content of the each executable file;
create an activation context based on the updated manifest;
determine using the component identification whether the activation context includes the requested software component; and
when it is determined that the activation context includes the requested software component,
activate the activation context and create an object of the requested software component using the activation context.

11. The apparatus of claim 10, wherein the application program includes a test runner program for running a unit-test of the requested software component.

12. The apparatus of claim 10, wherein the module run by the processor is further configured to:
search a system registry to determine whether the system registry includes the requested software component using the component identification when it is determined that the activation context does not include the requested software component; and
when it is determined that the system registry includes the requested software component, create an object of the requested software component by loading one or more executable files using a file path to the one or more executable files, wherein the file path is found in the system registry.

13. The apparatus of claim 10, wherein the module run by the processor is further configured to pass a reference to the object of the requested software component to the application program, wherein the reference is used to provide access to one or more services that are provided by the object.

14. The apparatus of claim 13, wherein the reference to the object includes a pointer to an IUnknown interface of the object.

15. The apparatus of claim 10, wherein the request is received through an invocation of a wrapper function that wraps a Win32 API function for creating an object of a requested component, wherein the component identification is an input parameter to the wrapper function and includes a COM component class ID (CLSID).

16. The apparatus of claim 15, wherein the Win32 API function includes CoCreateInstance function.

17. A non-transitory computer readable medium having executable instructions operable to cause an apparatus to:
receive from an application program a request to create an object of a software component, the request including a component identification of the requested software component;
access a type library associated with each of a plurality of executable files contained in a local file directory, wherein the type library includes an identification of the each executable file and library content including at least one of one or more classes, one or more interfaces, and one or more type definitions that are implemented by the each executable file;
update a manifest contained in a data file at runtime by enumerating the library content of the each executable file and adding to the data file the identification and the enumerated library content of the each executable file;
create an activation context based on the updated manifest;
determine using the component identification whether the activation context includes the requested software component; and
when it is determined that the activation context includes the requested software component,
activate the activation context; and
create an object of the requested software component using the activation context.

18. The computer readable medium of claim 17, wherein the type library includes one of an embedded type library and an external type library.

19. The computer readable medium of claim 17, wherein the plurality of executable files includes at least one of one or more stand-alone executable (EXE) files and one or more dynamic link library (DLL) files.

20. The computer readable medium of claim 17, wherein activating the activation context includes invoking one or more Win32 Activation Context functions, including ActivateActCtx.
